(19) United States
(12) Patent Application Publication
(10) Pub. No.: US 2005/0125832 A1
(43) Pub. Date: Jun. 9, 2005

(54) Method and apparatus for cost effective central transcoding of video streams in a video on demand system

(76) Inventors: Arthur P. Jost, Mount Laurel, NJ (US); Christopher W. Brown, Horsham, PA (US); Robert Edward Mack, Collegeville, PA (US); Lawrence D. Vince, Lansdale, PA (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/727,729

(22) Filed: Dec. 3, 2003

(51) Int. Cl. H04N 7/173

(52) U.S. Cl. 725/95; 725/86

(57) ABSTRACT

A communications system (10) for processing video signals in a video-on-demand service employs centralized transcoding in a way that a relatively small amount of transcoding equipment (15) is required, as opposed to transcoding every transport stream. In addition, the embodiments of the present invention do not require transitions from non-transcoded sessions to transcoded sessions. According to one aspect of the present invention, bandwidth is reserved at the node groups (14a-c) for transcoded services, and transcoding is initiated before the node group (14a-c) exceeds its assigned bandwidth. This method provides the opportunity to add additional transcoded services and start decreasing bandwidth allocations to individual channels or services without interrupting existing sessions.

### FIELD OF THE INVENTION

The present invention is directed generally to methods and apparatuses for encoding video data prior to transmission, and more particularly to a method and apparatus for encoding video data prior to transmission of video in a video on demand system.

### BACKGROUND

Video transcoding to reduce the bit rate for the purpose of increasing a number of Video On Demand (VOD) sessions that can be supported can be very expensive and/or very complex.

In one existing system, an expensive brute-force approach is used where transcoding is provided for every transport stream. This implementation is very expensive.

In another system, existing sessions are transitioned from non-transcoded sessions to transcoded sessions to reclaim bandwidth. This implementation is rather complex.

The present invention is therefore directed to the problem of developing a method and apparatus for reducing bandwidth in a VOD system so that more VOD sessions can be supported in a cost-effective and simple manner.

### SUMMARY OF THE INVENTION

The present invention solves these and other problems by providing inter alia centralized transcoding so that a relatively small amount of transcoding equipment is required, as opposed to transcoding every transport stream. The embodiments of the present invention do not require transitions from non-transcoded sessions to transcoded sessions.

According to one aspect of the present invention, bandwidth is reserved at the node groups for transcoded services, and transcoding is initiated before the node group exceeds its assigned bandwidth. This method provides the opportunity to add additional transcoded services and start decreasing bandwidth allocations to individual channels or services without interrupting existing sessions.

Other aspects of the present invention will be apparent to those reviewing the following drawings in light of the specification.

### BRIEF DESCRIPTION OF THE DRAWINGS

FIG. 1 depicts an exemplary embodiment of a central transcoding network architecture according to one aspect of the present invention.

FIG. 2 depicts an exemplary embodiment of a method for Quadrature Amplitude Modulation (QAM) allocations at a node group according to another aspect of the present invention.

FIG. 3 depicts an exemplary embodiment of a method for QAM utilization without transcoding according to still another aspect of the present invention.

FIG. 4 depicts an exemplary embodiment of a method for QAM utilization with bandwidth reserved for transcoded services according to yet another aspect of the present invention.

FIG. 5 depicts an exemplary embodiment of a method for QAM utilization with transcoded services according to still another aspect of the present invention.

FIG. 6 depicts an exemplary embodiment of a method for applying transcoding to multiple QAMs according to yet another aspect of the present invention.

FIG. 7 depicts an exemplary embodiment of a method for transcoding individual services in preparation for creating a STAT-MUX group according to still another aspect of the present invention.

FIG. 8 depicts an exemplary embodiment of a method for transcoding a full QAM according to yet another aspect of the present invention.

FIG. 9 depicts a flow chart of an exemplary embodiment of a method for processing video signals in a video on demand system.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

A centralized transcoder function enables MSO's to allow maximize use of bandwidth on the cable plant. There are generally a fixed number of QAM RF carriers available at the edge of the system providing a fixed amount of bandwidth to service the cable subscribers. Transcoding reduces the bit rate of digital video signals to allow extra video services to be squeezed into the available bandwidth in exchange for a reduction in video quality. Without transcoding the MSO would either have to size the system to provide enough edge devices and frequency space to meet peak demand, or they would have to deny service requests when capacity is exceeded during periods of peak utilization. A centralized transcoding solution allows the MSO to size the system to satisfy demand during normal usage and apply transcoding only when needed to satisfy peak demands.

The present invention provides inter alia an approach to centralized transcoding that is more cost-effective and simpler than existing implementations.

### BACKGROUND

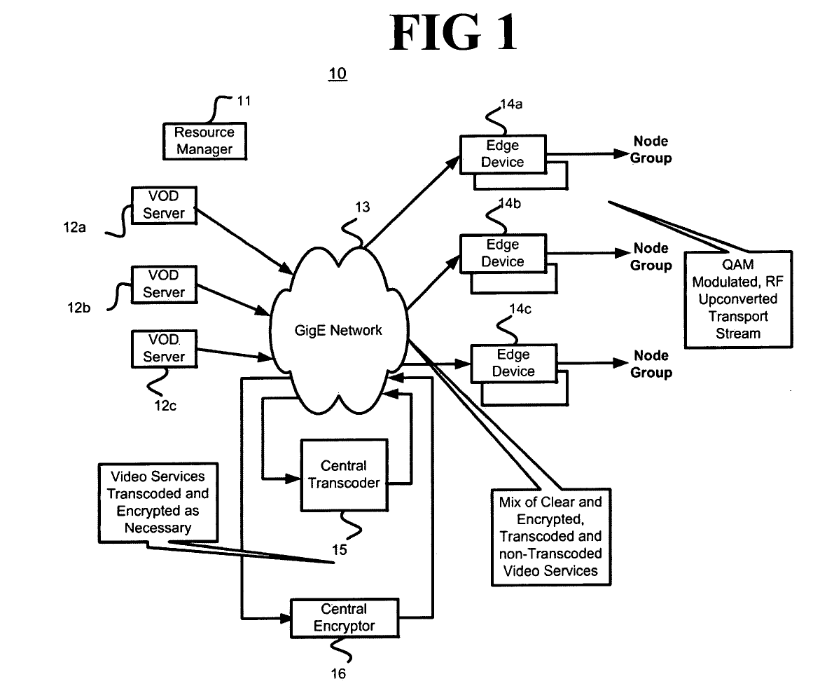

A high-level network diagram of an exemplary embodiment 10 for a centralized transcoding architecture is shown in FIG. 1. Video On Demand (VOD) servers 12a-12c (while only three are shown, many more could be implemented, depending upon total bandwidth and processing needs) are centralized along with transcoding and possibly encryption resources. Edge devices 14a-14c (while only three are shown, many more could be implemented, depending upon total bandwidth and processing needs) receive the digital video services that have been processed at the central facility (not shown, but within network 13) and perform Quadrature Amplitude Modulation (QAM) and RF upconversion resulting in a signal suitable for Hybrid Fiber Coaxial (HFC) distribution. A Resource Manager 11 coordinates and controls the distribution and processing of the video services from the VOD servers 12a-c through the transcoding 15 and encryption resources 16 for delivery to the edge devices 14a-c through the GigE 13 or other suitable network.

The central transcoder 15 has the ability to compress video services sourced by the VOD servers 12a-c, creating modified versions that have lower bit rates than the original services. When the demand for services exceeds the available bandwidth at a Node Group, the transcoder 15 can reduce the overall bandwidth requirement for video services, allowing additional services to be included in the transport streams. Depending on the rate of compression that can be tolerated, a significant increase in the number of services that can be transmitted on a node group is possible.

The central encryption resource 16 is shown here since it is likely to be part of a system that uses centralized transcoding. In such a system, the central encryptor 16 would process those services that require encryption after any transcoding.

In normal subscriber load situations transcoding would not be required and the services would be sent directly from the VOD server 12a-c to the edge device 14a-c, possible being encrypted first. As the load increased on a node group and bandwidth is consumed, services being directed to the node group are first processed by the central transcoder 15 to lower their bit rate. This is accomplished in a way that allows the MSO to target the transcoding resources only at the node groups that need additional capacity, thereby providing the same overall subscriber service capacity at less cost than dedicating more edge devices and frequency space to the node group.

### EXEMPLARY EMBODIMENTS

Centralized transcoding can be expensive and/or difficult to implement. The brute force approach provides transcoding for every multiplex that will be delivered to the system edge. This permits complete flexibility to transcode services as needed and can save on the number of edge devices and the physical frequency space required, but can be extremely expensive to implement overall due to the relatively high cost of transcoding.

An approach that reduces the amount of transcoding needed provides only enough transcoding resources to meet peak demand, and makes transcoding available to where transcoding is needed in the system at any instant in time. Being able to switch transcoding in at specific services and node groups as needed accomplishes this capability. The difficulty in this approach is that once the QAM resources at a node group are used up and transcoding is needed to free up some bandwidth for additional services, it is very difficult to turn on transcoding for existing sessions without creating errors or glitches in the video services. Such switching on transcoding can be accomplished without glitches, but the design and implementation have added complexity. This complexity includes: (1) having a VOD server output a second instance of a stream advanced in time to make up for the transcoder latency; (2) the transcoder synchronizing the post-transcoded material with the pre-transcoded material at some instance in time; and (3) a mechanism to signal an edge device or a router to synchronously replace the pre-transcoded material with the post-transcoded material.

The following approach overcomes these shortcomings and complexities.

### Exemplary Embodiment

According to one aspect of the present invention, an exemplary embodiment of centralized transcoding provides a straightforward way to provide limited, centralized transcoding resources sufficient for satisfying peak demands. This scheme avoids having to apply transcoding to existing sessions by reserving some amount of bandwidth at a node group for transcoded sessions. As part of system setup, each node group is configured to have a portion of one or more QAMs reserved for transcoding. As sessions are created on a node group the video services are delivered without transcoding until there is no space available that has not been reserved for transcoding. Additional sessions on that node group are then sent through the transcoder before being delivered to the edge. Note that there is initially no reduction in bandwidth or degradation in video quality since there is still enough bandwidth available for service. As the number of sessions on the node group continues to increase the transcoder begins to reduce bandwidth on the transcoded services as necessary. The result is that additional services can be delivered on the node group and no services had to go through a transition from non-transcoded to transcoded.

As old sessions on the node group drop off, new sessions can be routed through the transcoder to provide space for more sessions or to improve video quality, if necessary. As demand drops off, new sessions can be routed around the transcoder so the transcoding resources can be directed to another node group.

VOD sessions can be converted from non-transcode to transcode (and vice versa) without glitching the video during trick-play transitions (e.g., a pause, fast forward, etc.). Even though the VOD session is still active, the entry into trick play interrupts the video and provide an opportunity to re-route the video through (or bypass) a transcoder. The Resource Manager that maintains awareness of trick-play transitions can take advantage of this.

Using the Resource Manager to monitor and analyze usage patterns can help determine how much bandwidth to reserve at a node group and when to begin switching in transcoders. Different node groups are likely to have different utilization patterns with peaks occurring at different times and building up at different rates. In some cases, it may be necessary to reserve only a small amount of bandwidth for transcoding (say, one or two service worth) and rely on dropped sessions and trick-play transitions to provide opportunities to switch in additional transcoding. In other cases, a significant percentage of the overall node group bandwidth may need to be reserved for transcoding.

Transcoding is most efficient when services are grouped into statistical multiplexes or stat-muxes. The more services in a stat-mux the more efficient compression because bandwidth peaks in the individual services will tend to spread out rather than occur all at once. This approach would make use of stat-muxex to group the transcoded services, but this is not absolutely necessary. The bandwidth of a single service can be reduced by a transcoder, but the result will be more degradation to the video quality.

The transcoder may create stat-mux groups in two ways. One approach is for the transcoder to process all the services in the stat-mux group and create a multi-program transport stream (MPTS) at a constant bit rate for delivery to the edge device. The other approach is for the transcoder to create a collection of single-program transport streams (SPTS), each of variable bit rate that add up to a total bit rate that will fir into the targeted QAM signal at the edge. In this approach the edge device multiplexes the SPTSs into an MPTS before modulating.

Operational Scenario

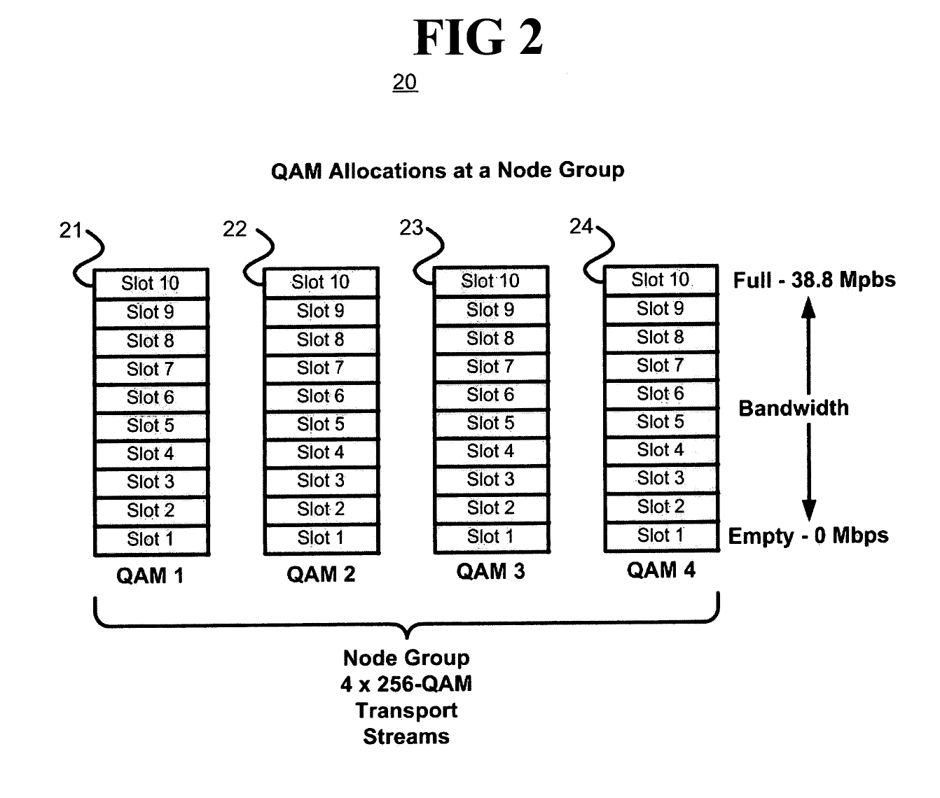

An exemplary embodiment 20 of a representation of the QAM resources at a node group is shown in FIG. 2. In this example, there are four 256-QAM transport streams 21-24 available for VOD usage at the node group. In this exemplary embodiment, each QAM is expected to carry up to ten video services if transcoding is not used, although other numbers of video services are possible. Initially, there are no VOD sessions being carried on the node group and all of the video slots are available.

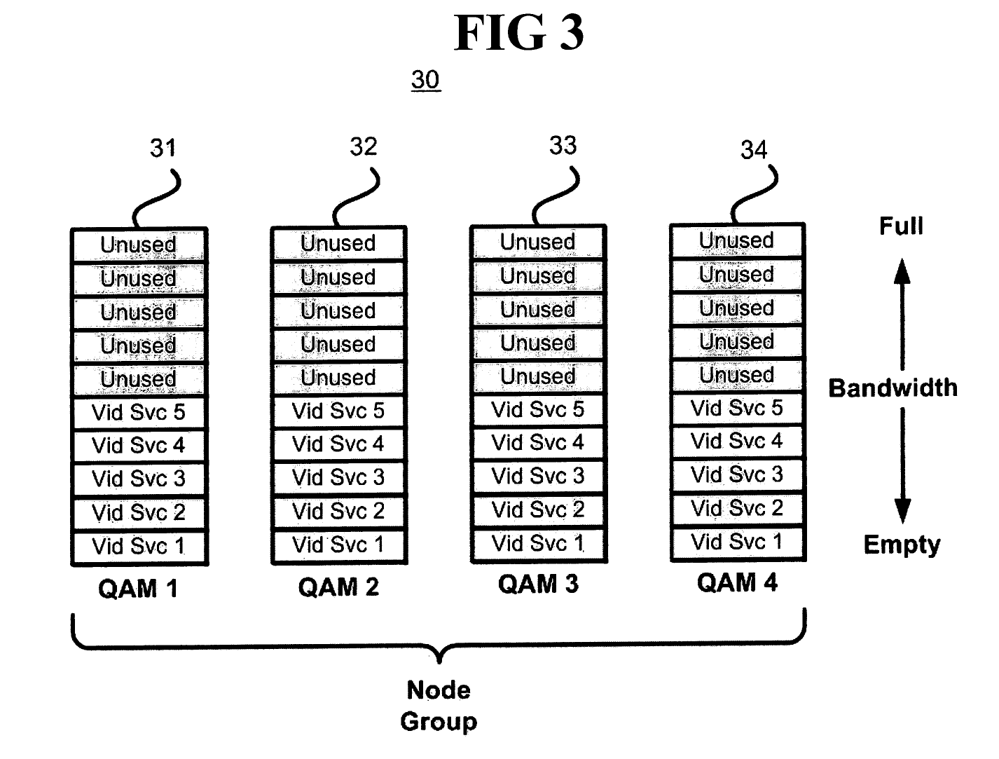

As VOD sessions come on-line, the slots are used for video services as shown in FIG. 3. In this example, the QAMs are filled horizontally, spreading the video sessions evenly across all four QAM transport streams. A vertical approach could also be used where an entire QAM is filled before moving on to the next QAM. Alternatively, some other assignment is possible. In the example shown in FIG. 3 only half of the QAM resources are being consumed and there is no need for transcoding at this point.

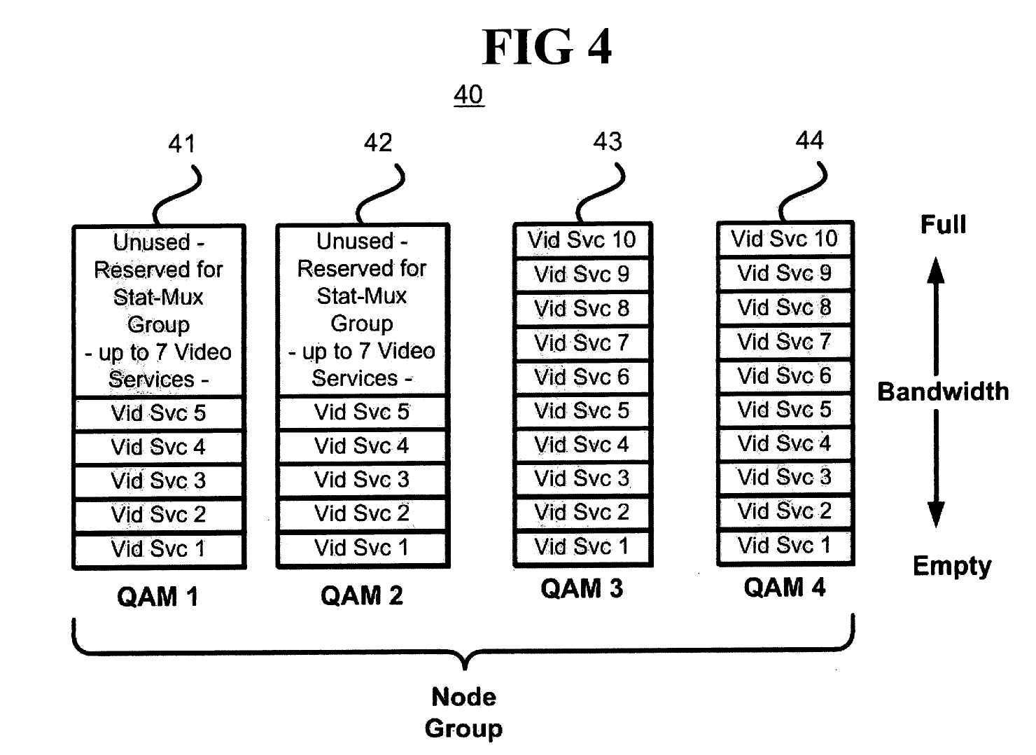

In the next diagram, FIG. 4, 75% of the QAM resources at the node group are being consumed, i.e., QAMs 3 and 4 are completely consumed, whereas QAMs 1 and 2 are each half consumed, the unused portion of which in each is reserved for transcoding services being processed by the central transcoder. According to the central transcoding scheme of the present invention, the remaining 25% of the resources of the node group (or the 50% of resources of each multiplexer 41 and 42) are reserved for transcoding, and any additional services that are to be carried on this node group will be processed by the central transcoder before being sent to the node group. This is one key difference between this approach and other central transcoding implementations. Reserving some amount of the node group resources and switching in transcoding before all the resources have been consumed simplifies the system design. The difficulty of redirecting existing session services through the transcoder to reclaim bandwidth at the node group is eliminated.

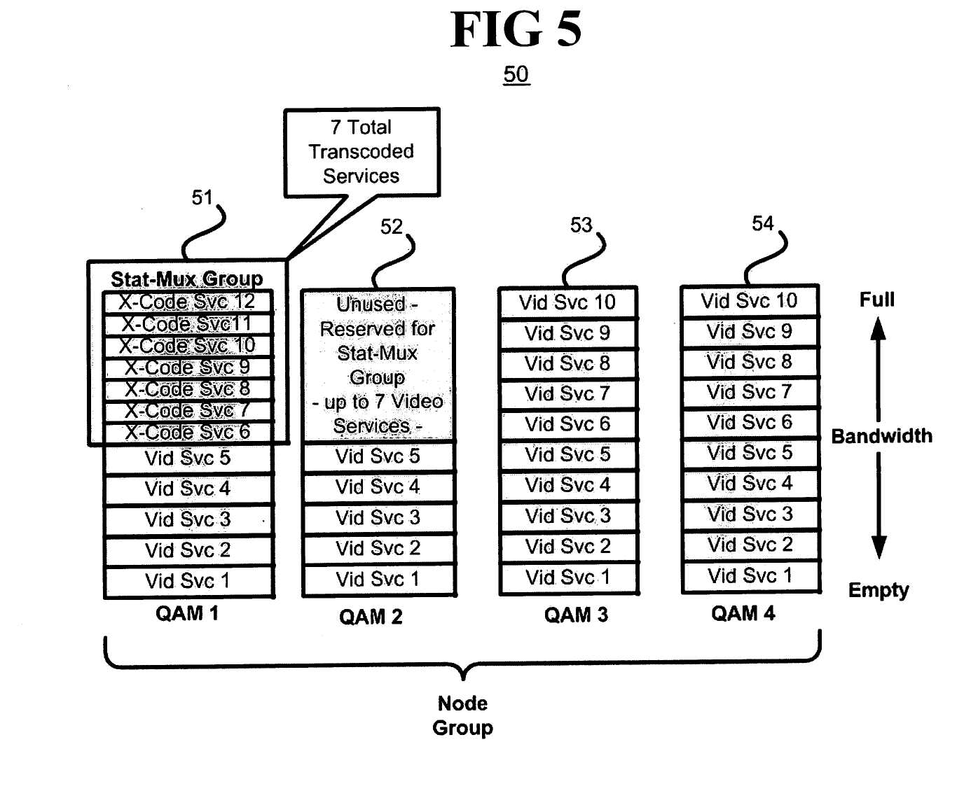

FIG. 5 shows how additional sessions are processed through the central transcoder, resulting in a re-multiplexed statistical-multiplexed group that uses the bandwidth of half of a QAM channel, or about 19 Mbps. If five non-transcoded services fit into 19 Mbps it is reasonable to expect seven transcoded services in a stat-mux group to fit into the same 19 Mbps with only a small reduction in video quality. Different amounts of channels can be carried in the bandwidth reserved for transcoding depending upon the capability of the transcoder and the permitted signal degradation.

While transcoding will certainly enable an increase in the amount of channels carried over the same bandwidth, the increase in capacity is dependent on the type of transcoding, which is not limited by the methods herein. Once central transcoding is being provided, of any capability, the methods of the present invention enable a simple utilization of this central transcoding resource without the normal concomitant problems associated with converting an existing video session to a transcoded session from a non-transcoded session. By reserving some bandwidth of one or more multiplexers in each node group for transcoded services before the capacity of the one or more multiplexers is used up, the methods of the present invention permit utilization of the central transcoding without interrupting existing video sessions or complicating the system architecture to avoid interrupting existing video sessions.

FIG. 5 shows the stat-mux group fully loaded with seven services. Initially, the stat-mux group in QAM 51 is empty and services are added, being processed through the transcoder, until the maximum number of services is reached.

Note that video service bit-rates and compression ratios shown here are only examples. More drastic compression is also possible with increased video degradation. The amount of bandwidth resource reserved for transcoding at the node group is also for example only. If may be sufficient to reserve only 25% of a node group's bandwidth for transcoding depending on usage patterns. It is important, however, to reserve a large enough segment of bandwidth to make stat-muxing efficient to minimize degradation to video quality.

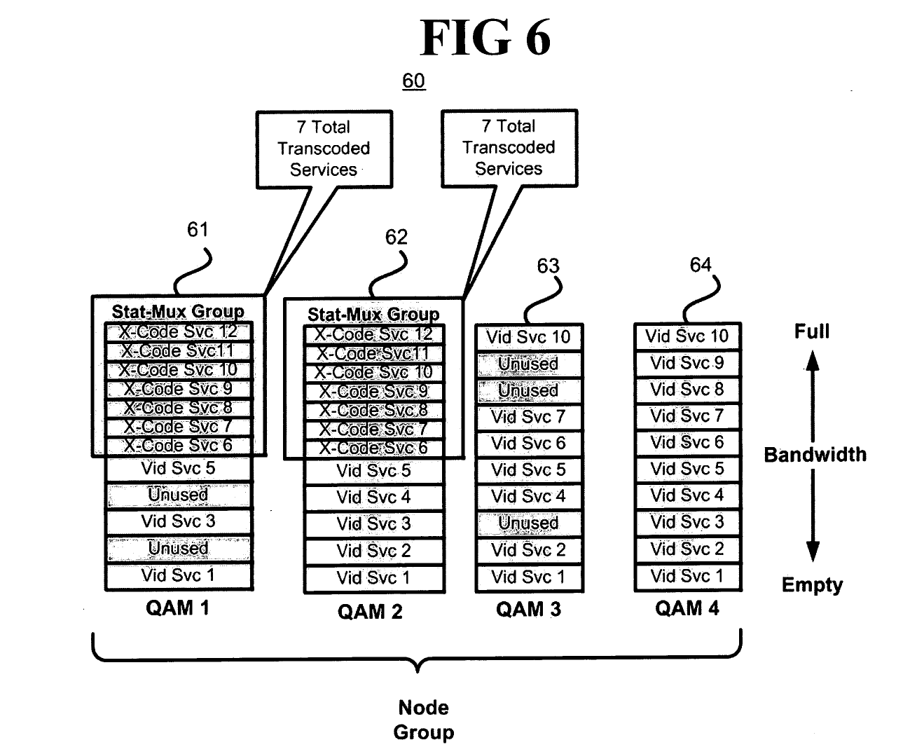

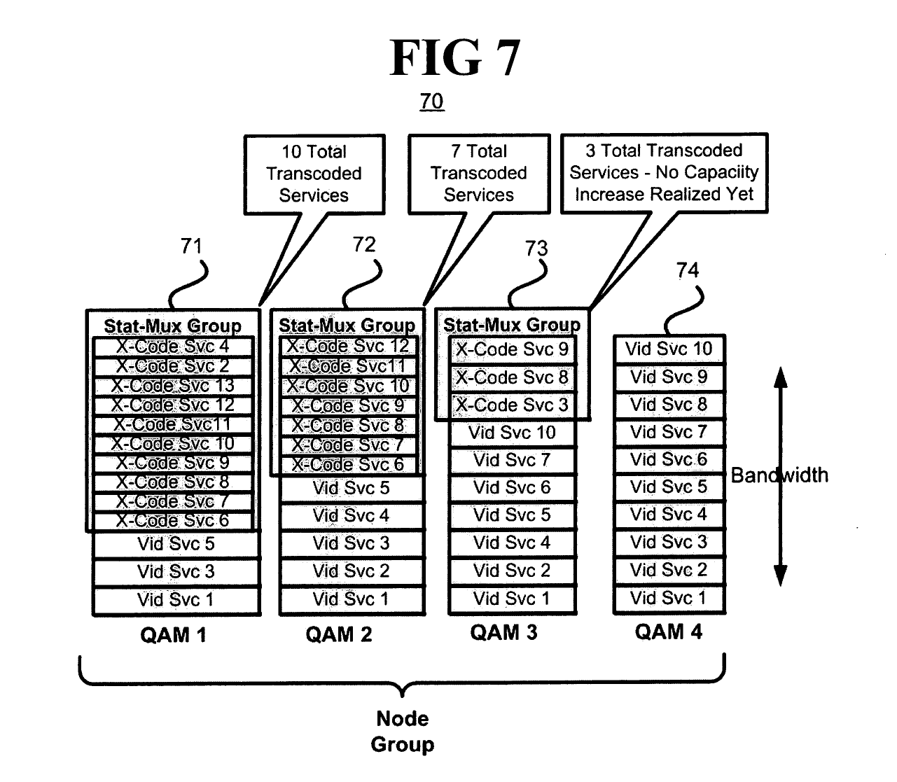

Eventually a second stat-mux group may be formed on another QAM as shown in FIG. 6. Also note that over time existing sessions throughout the node group will be terminated, allowing for opportunities for additional stat-muxing, if load conditions warrant. This is shown in FIG. 7 where the unused slots that were created from dropped sessions (channels 3, 8 and 9 of QAM 3) are replaced with services that are being processed by the transcoder (note that channels 3, 8 and 9 are now part of the mux group in QAM 3), but are still at full bandwidth. These services will continue to be added at full bandwidth until a big enough segment of bandwidth is available to allow effective compression within the stat-mux group.

Also shown in FIG. 7 is the expansion of the original stat-mux group to take in more bandwidth and include more services on QAM 1 as older sessions are terminated. The more bandwidth is dedicated to the stat-mux group the higher the compression ratio can be achieved without additional loss of video quality. For example, in FIG. 7, channels 2 and 4 of QAM 1 have been added to the stat-mux group in QAM 1, thereby enabling the stat-mux group of QAM 1 to process ten video services rather than seven.

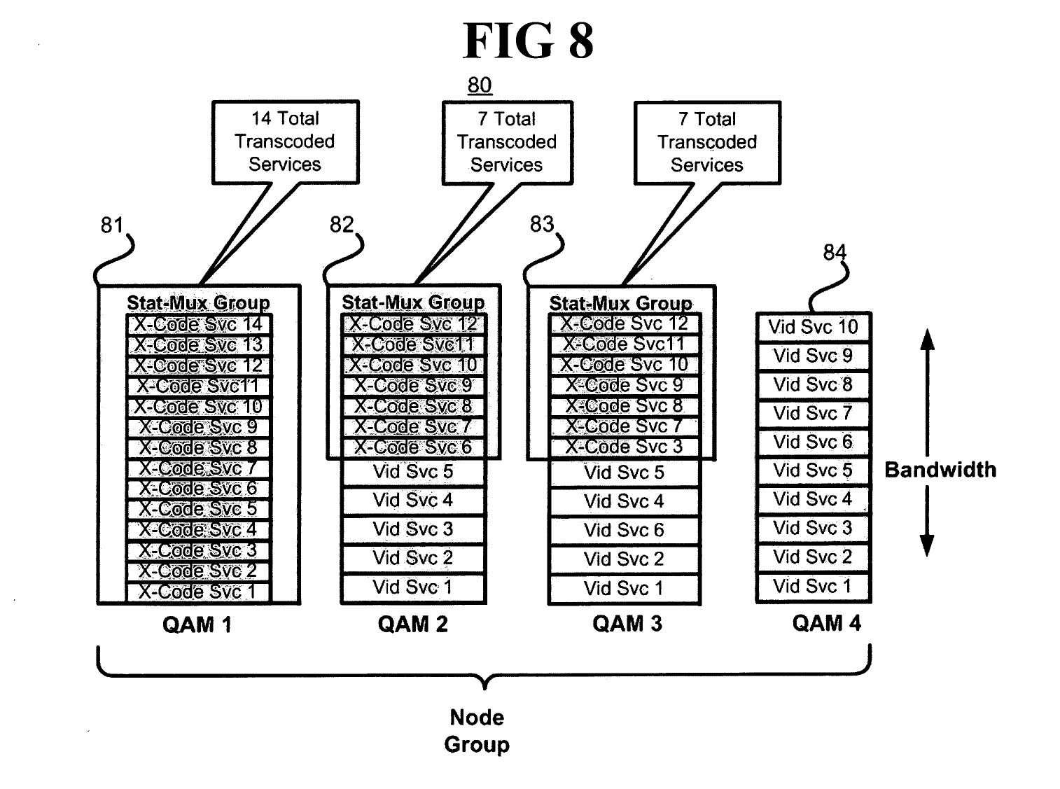

FIG. 8 shows the case where the stat-mux group is expanded to include a full QAM. In this example QAM 1 now has fourteen services, QAM 2 and QAM 3 each have twelve services, and QAM 4 has its original ten services. The node group capacity has been increased from the original forty services without transcoding to a total of 48 services utilizing central transcoding, which is a 20% increase.

As demand at the node group falls off the transcoding resources can be removed and applied to other areas of the system as needed.

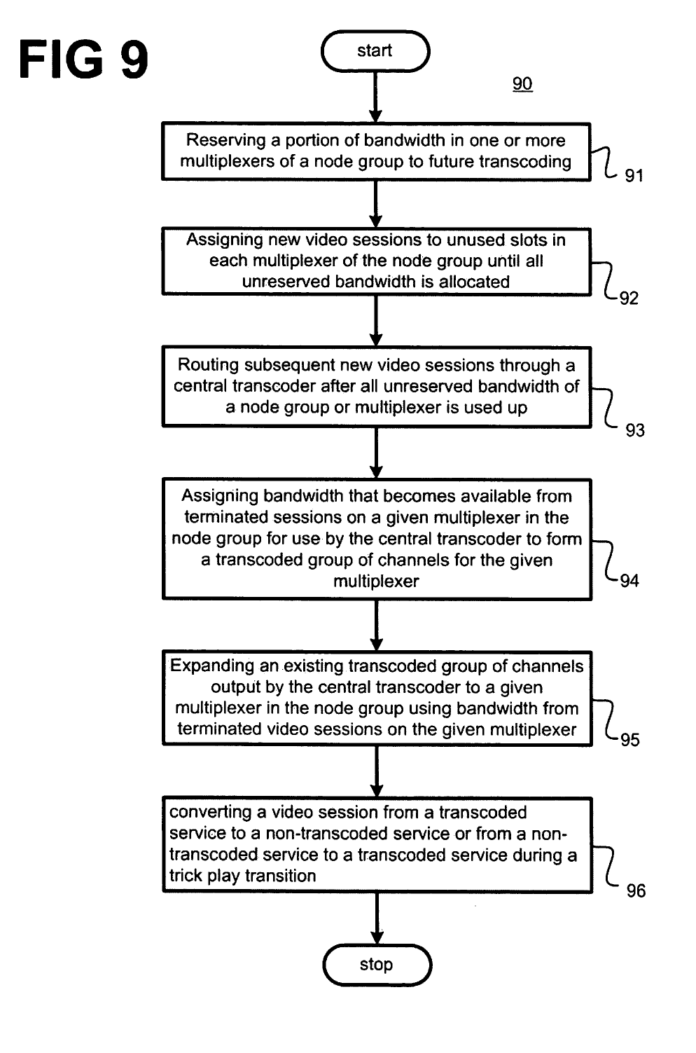

Turning to FIG. 9, shown therein is an exemplary embodiment of a method 90 for processing video signals in a video-on-demand system.

In step 91, a portion of bandwidth in one or more multiplexers of a node group is reserved for future transcoding.

In step 92, new video sessions are assigned to unused slots in each multiplexer of the node group until all unreserved bandwidth is allocated.

In step 93, subsequent new video sessions are routed through a central transcoder after all unreserved bandwidth of a node group or multiplexer is used up.

In step 94, bandwidth that becomes available from terminated sessions on a given multiplexer in the node group is assigned for use by the central transcoder to form a transcoded group of channels for the given multiplexer. An example of a transcoded group of channels includes a statistical multiplexed group of channels. The statistical multiplexed group can be created by creating a multi-program transport stream at a constant bit rate for delivery to an edge device from all services in the statistical multiplex group or by creating a plurality of single-program transport streams during transcoding, each having a variable bit rate that adds up to a total bit rate that will fit into the multiplexer. In the latter case, the single-program transport streams are multiplexed at the edge device into a multi-program transport stream before subsequent modulating by the edge device.

In step 95, an existing transcoded group of channels output by the central transcoder to a given multiplexer in the node group is expanded using bandwidth from terminated video sessions on the given multiplexer.

In step 96, a video session is converted from a transcoded service to a non-transcoded service or from a non-transcoded service to a transcoded service during a trick-play transition. An example of a trick play transition includes a transition from a playback operation to an fast-forward operation, a rewind operation or a pause operation. By interrupting the video stream, the user provides the system the opportunity to switch the video from or to a transcoding operation, without a glitch being apparent to the user.

According to another aspect of the present invention, a method for processing channels in a communications system includes reserving a predetermined amount of bandwidth in a multiplexer for future transcoding, and performing transcoding on one or more new channels after all unreserved bandwidth of the multiplexer is allocated. In this embodiment, one or more new channels are assigned to one or more unused slots in the multiplexer until all unreserved bandwidth is allocated before performing said transcoding.

The above embodiments may be implemented in Motorola's Smartstream Central Transcoder (SCT), the Smartstream Resource Manager (SRM) and other related VOD devices and systems. Other hardware implementations will be apparent to those of skill in this art upon review of the above.

Although various embodiments are specifically illustrated and described herein, it will be appreciated that modifications and variations of the invention are covered by the above teachings and are within the purview of the appended claims without departing from the spirit and intended scope of the invention. For example, a number of channels and multiplexers are shown for each node group, however, other numbers could easily be implemented without departing from the scope of the present invention. Furthermore, these examples should not be interpreted to limit the modifications and variations of the invention covered by the claims but are merely illustrative of possible variations.

1. A method (90) for processing video signals in a video-on-demand system (10) comprising:
reserving (91) a predetermined amount of bandwidth in one or more multiplexers (21-24) of a node group to future transcoding;
assigning (92) one or more new video sessions to one or more unused slots in each multiplexer (21-24) of the node group until all unreserved bandwidth is allocated; and
routing (93) one or more subsequent new video sessions through a central transcoder (15) after all unreserved bandwidth of a node group is allocated.

2. The method (90) according to claim 1, further comprising:
assigning (94) bandwidth that becomes available from one or more terminated video sessions on a given multiplexer (21-24) in the node group for use by the central transcoder (15) to form a transcoded group of channels for the given multiplexer (21-24).

3. The method (90) according to claim 2, wherein a transcoded group of channels includes a statistical multiplexed group of channels.

4. The method (90) according to claim 1, further comprising:
expanding (95) an existing transcoded group of channels output by the central transcoder (15) to a given multiplexer (21-24) in the node group using bandwidth from one or more terminated video sessions on the given multiplexer (21-24).

5. The method (90) according to claim 1, further comprising:
converting (96) a video session from a non-transcoded service to a transcoded service during a trick play transition.

6. The method (90) according to claim 1, further comprising:
converting (96) a video session from a transcoded service to a non-transcoded service during a trick play transition.

7. The method (90) according to claim 5, wherein a trick play transition includes a transition from a playback operation to an operation selected from the group of: fast-forward, rewind and pause.

8. The method (90) according to claim 6, wherein a trick play transition includes a transition from a playback operation to an operation selected from the group of: fast-forward, rewind and pause.

9. A method (90) for processing a plurality of channels in a communications system (10) comprising:
reserving (91) a predetermined amount of bandwidth in a multiplexer (21-24) to future compression or transcoding; and
performing (93) transcoding or compression on one or more new channels after all unreserved bandwidth of the multiplexer (21-24) is allocated.

10. The method (90) according to claim 9, further comprising:
assigning (92) one or more new channels to one or more unused slots in the multiplexer (21-24) until all unreserved bandwidth is allocated before performing said transcoding.

11. The method (90) according to claim 9, further comprising:
forming (49) a transcoded or compressed group of channels for the multiplexer (21-24) from bandwidth that becomes available from one or more terminated channels in the multiplexer (21-24).

12. The method (90) according to claim 11, wherein the forming includes creating a compressed group of channels.

13. The method (90) according to claim 12, wherein the creating includes creating a single transport stream at a constant bit rate for delivery to an edge device (14a-c) from all services in the compressed group of channels.

14. The method (90) according to claim 12, wherein the creating includes:
creating a plurality of single transport streams during transcoding, each having a variable bit rate that adds up to a total bit rate that will fit into the multiplexer (21-24); and
multiplexing the plurality of single transport streams at the edge device (14a-c) into one transport stream before modulating by the edge device (14a-c).

15. The method (90) according to claim 9, further comprising:
expanding (95) an existing transcoded group of channels associated with the multiplexer (21-24) using bandwidth from one or more terminated channels assigned to the multiplexer (21-24).

16. The method (90) according to claim 9, further comprising:
converting (96) a channel from a non-transcoded service to a transcoded service during a user initiated interruption in the channel.

17. The method (90) according to claim 9, further comprising:
converting (96) a channel from a transcoded service to a non-transcoded service during a user initiated interruption in the channel.

18. The method (90) according to claim 16, wherein a user initiated interruption in the channel includes a transition from a playback operation to an operation selected from the group of: fast-forward, rewind and pause.

19. The method (90) according to claim 17, wherein a user initiated interruption in the channel includes a transition from a playback operation to an operation selected from the group of: fast-forward, rewind and pause.

20. An apparatus (10) for processing video signals comprising:
a central transcoder (15);
one or more video servers (12a-c), each outputting one or more video signals requested by users;
one or more edge devices (14a-c) each outputting a node group of signals for transmission to each of the users, wherein each edge device (14a-c) includes one or more multiplexers (21-24), and each multiplexer (21-24) includes a plurality of channel slots;
a network (13) coupling the one or more video servers (12a-c) to the one or more edge devices (14a-c) and the central transcoder (15); and
a processor (11) assigning each of the one or more video signals output by the one or more servers (12a-c) to one channel slot of the one or more channel slots in one multiplexer (21-24) of the one or more multiplexers (21-24) in one edge device (14a-c) of the one or more edge devices (14a-c), said processor (11):
(i) reserving a predetermined amount of bandwidth in each of the one or more edge devices (14a-c) to future transcoding,
(ii) assigning one or more new user requested video signals to one or more unused channel slots in a particular multiplexer (21-24) of the one or more multiplexers (21-24) of a particular edge device (14a-c) of the one or more edge devices (14a-c) until all unreserved bandwidth is allocated in the particular edge device (14a-c) of the one or more edge devices (14a-c), and
(iii) routing one or more subsequent new user requested video signals that is designated for a particular edge device (14a-c) of the one or more edge devices (14a-c) through the central transcoder (15) after all unreserved bandwidth of the particular edge device (14a-c) of the one or more edge devices (14a-c) is allocated.

21. The apparatus (10) according to claim 20, wherein said processor (11):
assigns bandwidth associated with a channel slot that becomes available from one or more terminated video sessions on a given multiplexer (21-24) of the one or more multiplexers (21-24) in a given edge device (I 4a-c) of the one or more edge devices (14a-c) for use by the central transcoder (15) to form a transcoded group of channels for the given multiplexer (21-24).

22. The apparatus (10) according to claim 21, wherein a transcoded group of channels includes a statistical multiplexed group of channels.

23. The apparatus (10) according to claim 20, wherein said processor (11):
expands an existing transcoded group of channels output by the central transcoder (15) to a given multiplexer (21-24) of the one or more multiplexers (21-24) in a given edge device (14a-c) of the one or more edge devices (14a-c) using bandwidth from one or more terminated video sessions on the given multiplexer (21-24).

24. An apparatus (10) for processing video signals output by one or more video servers (12a-c), each outputting one or more video signals requested by one or more users, said apparatus (10) comprising:
a central transcoder (15);
one or more edge devices (14a-c) each outputting a node group of signals for transmission to each of the one or more users, wherein each edge device (14a-c) includes one or more multiplexers (21-24), and each multiplexer (21-24) includes a plurality of channel slots; and
a processor (11) assigning each of the one or more video signals to one channel slot of the one or more channel slots in one multiplexer (21-24) of the one or more multiplexers (21-24) in one edge device (14a-c) of the one or more edge devices (14a-c), said processor (11):
(i) reserving a predetermined amount of bandwidth in each of the one or more multiplexers (21-24) in each of the one or more edge devices (14a-c) for future transcoding; and
(ii) routing one or more new user requested video signals designated for a given edge device (14a-c) of the one or more edge devices (14a-c) through the central transcoder (15) after all unreserved bandwidth of the given edge device (14a-c) is allocated.

25. The apparatus (10) according to claim 24, further comprising:
a network (13) coupling the one or more video servers (12a-c) to the one or more edge devices (14a-c) and the central transcoder (15).

26. The apparatus (10) according to claim 24, wherein the processor (11):
assigns one or more new requested video signals to one or more unused slots in a given multiplexer (21-24) of the given edge device (14a-c) until all unreserved bandwidth in the given edge device (14a-c) is allocated before routing the one or more new user requested video signals through the central transcoder (15).

27. The apparatus (10) according to claim 24, wherein the central transcoder (15):
forms a transcoded group of channels for a given multiplexer (21-24) from bandwidth that becomes available from one or more terminated video sessions in given multiplexer (21-24).

28. The apparatus (10) according to claim 27, wherein the central transcoder (15) forms a statistical multiplex group.

29. The apparatus (10) according to claim 28, wherein the central transcoder (15) forms the statistical multiplex group by creating a multi-program transport stream at a constant bit rate for delivery to the edge device (14a-c) of the given multiplexer (21-24) from all services in the statistical multiplex group.

30. The apparatus (10) according to claim 28, wherein the central transcoder (15) forms the statistical multiplex group by creating a plurality of single-program transport streams during transcoding, each having a variable bit rate that adds up to a total bit rate that will fit into the given multiplexer (21-24), and the edge device (14a-c) of the given multiplexer multiplexes the plurality of single-program transport streams into a multi-program transport stream.
